(19) United States
(12) Patent Application Publication
(10) Pub. No.: US 2010/0070353 A1
(43) Pub. Date: Mar. 18, 2010

(54) Method and System for Sponsoring Recipients of Humanitarian Aid

(75) Inventor: Robert Landures Steed, Springville, UT (US)

Correspondence Address: HOLME ROBERTS & OWEN, LLP, 299 SOUTH MAIN, SUITE 1800, SALT LAKE CITY, UT, 84111, US

(73) Assignee: TRIVANI INTERNATIONAL, LLC, Springville, UT (US)

(21) Appl. No.: 12/561,456

(22) Filed: Sep. 17, 2009

Related U.S. Application Data
(60) Provisional application No. 61/097,791, filed on Sep. 17, 2008.

(51) Int. Cl. G06Q 50/00; G06Q 30/00; G06Q 10/00

(52) U.S. Cl. 705/14.1; 705/30; 705/329

(57) ABSTRACT

A method and system for sponsorship of a recipient by a distributor in an MLM system for purposes of providing humanitarian aid. In the method, a multi-level distribution system is provided. A plurality of distributors markets and sells a product or service to consumers through the multi-level distribution system. A first goal is defined for a distributor in the multi-level distribution system. In addition, a pool of recipients is provided. The pool of recipients receives humanitarian aid, in part based on the actions by distributors in the multi-level distribution system. It is determined when the distributor achieves the first goal. Upon achieving the first goal, a recipient is assigned to the distributor. Sponsorship of the recipient by the distributor is provided. Specifically, sponsorship allows the recipient to receive humanitarian aid, as long as the distributor satisfies conditions of the first goal.

### CROSS REFERENCE TO RELATED APPLICATIONS

The present invention claims priority to and the benefit of Provisional Application No. 61/097,791, entitled “Method and System for Sponsoring Recipients of Humanitarian Aid,” Attorney Docket No. 52957-10000, filed on Sep. 17, 2008, which is herein incorporated by reference in its entirety.

### BACKGROUND OF THE INVENTION

1. Field of Invention

The present invention relates to the field of multi-level marketing (MLM) systems. Specifically, the present invention relates to the sponsorship of a child by a participant in an MLM system for purposes of providing humanitarian aid.

2. The Relevant Technology

MLM systems provide for marketing and distribution of products and services to consumers outside of a traditional retail environment. That is, instead of providing products and services at the retail level (e.g., store), MLM systems provide an alternative distribution model, which results in reduced cost to the consumer.

In general, an MLM system allows a company to distribute a product or service to consumers through one or more distributors or sales associates. In particular, the distributor purchases the product or service at wholesale. The sale of the product or service is more direct to the consumer, in part since there is no need to support a retail infrastructure. The sale price to the consumer is the wholesale price with little or no markup. The distributor earns a commission on each sale of the product or service.

In addition, the distributor can build an organization of distributors, each of which also sell and distribute the product or service to consumers. That is, the distributor is able to recruit other distributors to participate in the MLM system. As such, in a sense, the parent distributor builds a parent organization of child distributors. Moreover, the parent distributor shares in the commissions earned by each of the child distributors.

A particular organization can grow larger since each child distributor potentially can recruit other distributors to participate in the MLM system. In that case, the child distributor builds a child organization, or subset of the parent organization. As such, not only is the child distributor able to share in the commissions earned by each of the distributors in the subset, but a parent distributor is also able to share in the commissions earned by each of its child distributors. That is, the parent distributor is able to share in the commission of downline sales made by all distributors in the parent organization.

However, in an MLM system, non-retention of participants may lead to weakness or failure in the business. For instance, a distributor may become discouraged in the performance of his or her organization of distributors, which may show limited or negative growth in commissions. Without further beneficial reasons, the distributor may opt to withdraw from participating in the MLM system, thereby affecting the payments to upstream distributors within one or more organizations of distributors.

### SUMMARY OF THE INVENTION

What is described in the present invention is a method and system for sponsorship of a recipient (e.g., child) by a distributor in an MLM system for purposes of providing humanitarian aid to the recipient.

In one embodiment, a method for promoting humanitarian aid is described. A multi-level distribution system is provided. A plurality of distributors markets and sells a product or service to consumers through the multi-level distribution system. A first goal is defined for a distributor in the multi-level distribution system. In addition, a pool of recipients is provided. The pool of recipients receives humanitarian aid, in part based on the actions by distributors in the multi-level distribution system. It is determined when the distributor achieves the first goal. Upon achieving the first goal, a recipient is assigned to the distributor. Sponsorship of the recipient by the distributor is provided. Specifically, sponsorship allows the recipient to receive humanitarian aid, as long as the distributor satisfies conditions of the first goal.

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1 is an illustration of a hierarchy of a multi-level distribution system, in accordance with one embodiment of the present invention.

FIG. 2 is an illustration of a network of distributors and a system that is capable of creating relationships between a recipient and a sponsor distributor for purposes of providing humanitarian aid, in accordance with one embodiment of the present invention.

FIG. 3 is a flow diagram illustrating a method for providing humanitarian aid to a recipient, such as a child, in accordance with one embodiment of the present invention.

FIG. 4 is a data flow diagram illustrating the flow of information in a system capable of facilitating relationships between a recipient and a sponsor distributor of a multi-level distribution system, in accordance with one embodiment of the present invention.

FIG. 5 is a flow diagram illustrating a method for providing humanitarian aid to recipients that implements the method of FIG. 4, in accordance with one embodiment of the present invention.

FIG. 6 is an illustration of a status report of the benefits received by a child recipient that is accessible by the child's sponsor, in accordance with one embodiment of the present

FIG. 7 is a flow chart of a method for providing humanitarian aid to a group of recipients (e.g., village), in accordance with one embodiment of the present invention.

### DETAILED DESCRIPTION OF THE PREFERRED EMBODIMENTS

Reference will now be made in detail to the preferred embodiments of the present invention, a method and system for sponsorship of a recipient (e.g., child) by a distributor in a multi-level distribution system for purposes of providing humanitarian aid to the recipient. While the invention will be described in conjunction with the preferred embodiments, it will be understood that they are not intended to limit the invention to these embodiments. On the contrary, the invention is intended to cover alternatives, modifications and equivalents which may be included within the spirit and scope of the invention as defined by the appended claims.

Accordingly, embodiments of the present invention provide for humanitarian aid to be given to a recipient. In addition, embodiments of the present invention provide for an incentive to distributors to continue to participate in a multi-level distribution system. In addition, embodiments of the present invention provide for humanitarian aid to be given to a group of recipients (e.g., a village) in an effort to guide that group towards self-sufficiency.

### 1. Notation and Nomenclature

Embodiments of the present invention can be implemented on software running on a computer system. The computer system can be a personal computer, notebook computer, server computer, mainframe, networked computer, handheld computer, personal digital assistant, workstation, and the like. This software program is operable for facilitating the sponsorship of a recipient by a distributor of an MLM system for purposes of providing humanitarian aid to the recipient. In one embodiment, the computer system includes a processor coupled to a bus and memory storage coupled to the bus. The memory storage can be volatile or non-volatile and can include removable storage media. The computer can also include a display, provision for data input and output, etc.

Some portions of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “tracking,” “assigning,” “determining,” “providing,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

### 2. Multi-Level Distribution System

Throughout the specification, the term “multi-level distribution system” is generally used to describe an MLM system, or network marketing system, or any similarly based marketing system. In general, a multi-level distribution system provides a network of distributors, each of which is able to distribute a good or service of a parent company.

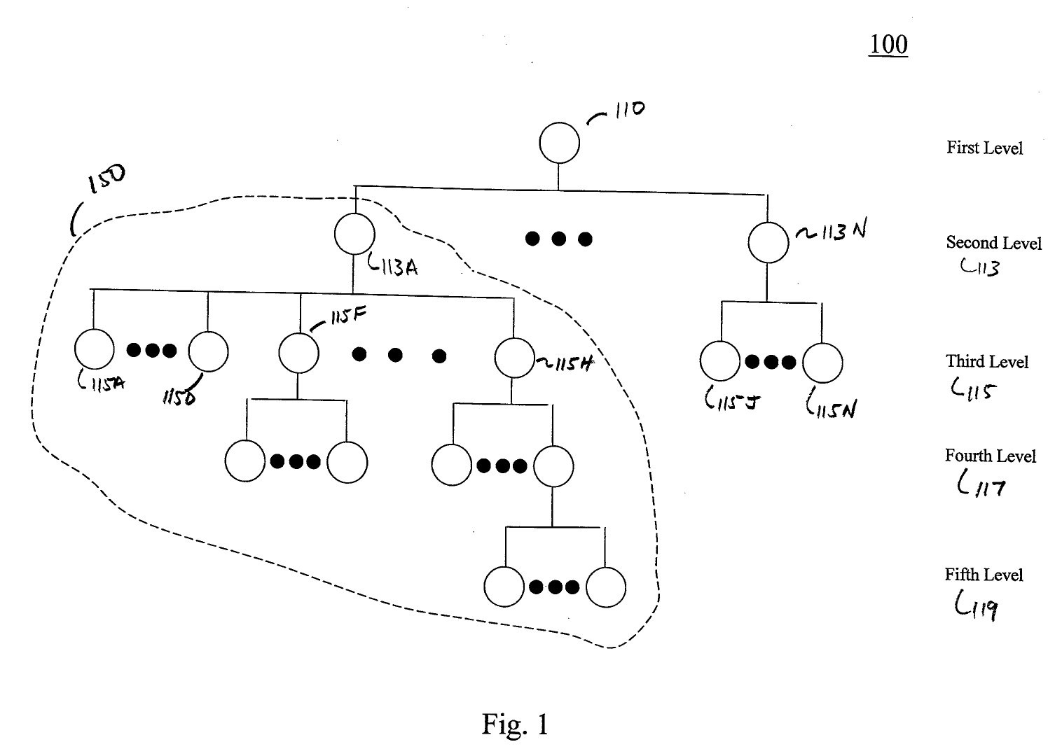

For instance, FIG. 1 is an exemplary illustration of a hierarchy of a multi-level distribution system 100. As shown, the network of distributors includes multiple levels of distributors. Though only five levels are shown, multi-level distribution system 100 is capable of supporting less than five levels or more than five levels, depending on its stage of development. That is, the multi-level distribution system is dynamic, and can increase or decrease in size and organization depending on the number and configuration of distributor participants. Distributor 110 is at the top or first level. As such, all remaining distributors are at a level that is lower than distributor 110. In addition, all the distributors shown in FIG. 1, as a whole, form an organization of distributors. In particular, the organization that includes all the distributors in the multi-level distribution system 100 is formed by distributor 110, such that distributors at the second through fifth levels are downline distributors of distributor 110. As will be described below, each distributor in the multi-level distribution system can form an organization of downline distributors.

A second level of distributors 113 is located directly below distributor 110 in the hierarchy, and include distributors 113A-N. This second level of distributors is recruited by distributor 110 to participate in the multi-level distribution system 100. As such, in one implementation, distributor 110 recruits, trains, and guides the second level of distributors 113 for success within the multi-level distribution system.

Additionally, the third level of distributors 115 includes distributors 115A-N. As shown in FIG. 1, distributor 113A at the second level 113 recruits various distributors, to include distributors 115A-H. Also, distributor 113N at the second level recruits various distributors, to include distributors 115J-N

While the entire group of distributors shown in FIG. 1 forms an organization headed by distributor 110 at the highest level, each distributor can head its own organization. For instance, organization 150 is headed by distributor 113A, at the second level 113. Organization 150 includes distributors at the third level 115, fourth level 117, and fifth level 119. As such, the multi-level distribution system 100 can include or be configured into one or more organizations, each of which are headed by a distributor.

Moreover, each of the distributors receive a commission based on the volume of product or services bought by that distributor from the parent company, for self use, or for resale to consumers. In addition, each distributor is associated with an organization (e.g., organization 150) of downline or lower-level distributors. To reduce infrastructure costs, each distributor deals directly with the parent company in terms of ordering, and receiving product or service for delivery to the consumer. As an added benefit, commissions from the downline distributors are received by upstream distributors. Without going into detail, these commissions depend on the separation of levels between the downline distributor and the lower level distributor.

### 3. Sponsored Humanitarian Aid

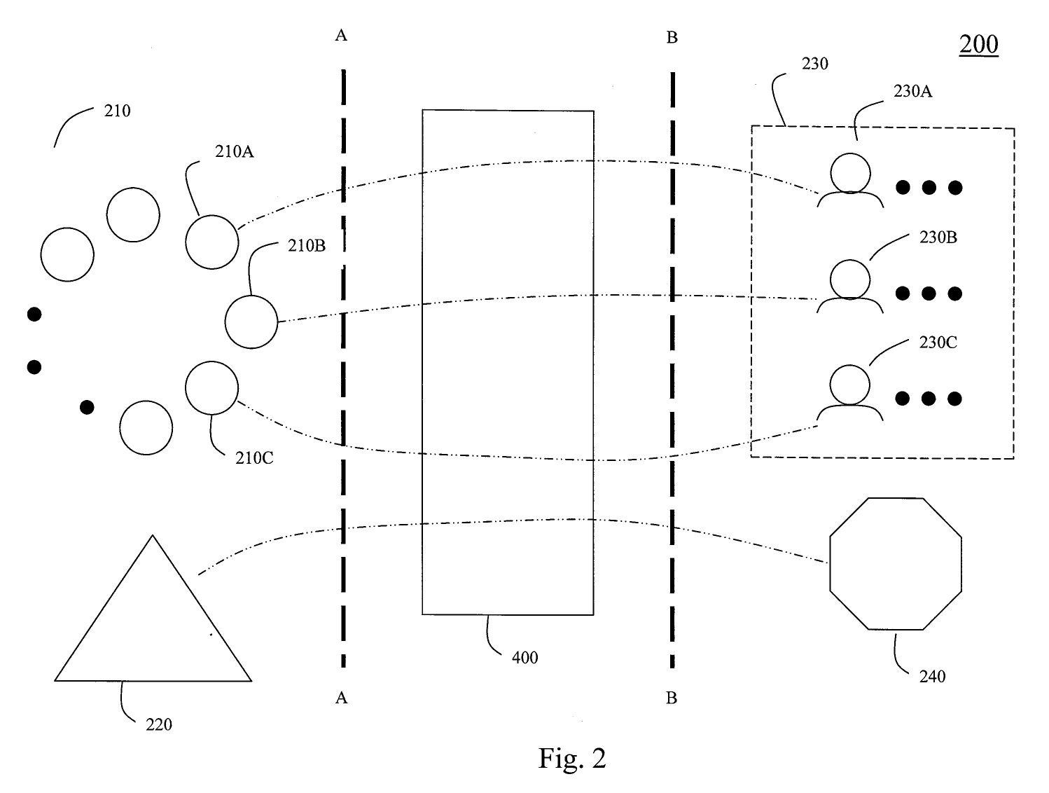

FIG. 2 is an illustration of a multi-level distribution system and a centralized system that is capable of coordinating the creation of relationships between a recipient and a sponsor distributor for purposes of providing humanitarian aid, in accordance with one embodiment of the present invention.

As shown in FIG. 2, one or more multi-level distribution systems are represented to the left of line A-A. For example, a group of distributors 210 is part of a first multi-level distribution system. The group 210 includes N distributors, such as distributor 210A, 210B, and 210C. As shown, the group 210 is in no particular hierarchical order, since sponsorship of a recipient is not dependent on a sponsor distributor's placement in the multi-level distribution system, in one embodiment.

Also shown in FIG. 2 is an organization of distributors 220 in a second multi-level distribution system. The organization 220 may include or be part of the first multi-level distribution system that includes group 110 of distributors. For instance, organization 220 is analogous to organization 150 of FIG. 1, and includes a distributor at the head of the organization and one or more downline distributors. In this case, sponsorship is dependent on the hierarchy of distributors.

Each of the distributors to the left of line A-A, to include distributors in organization 220, are communicatively coupled to the system 401. System 401 is capable of facilitating sponsorships with recipients by a distributor, or a group of distributors (e.g., organization), for purposes of providing humanitarian aid. The recipients of humanitarian aid are located to the right of line B-B. For instance, a recipient may be an identified individual that is selected from a plurality of individuals 230. In one embodiment, the recipient is a child. In addition, the recipient may be a group of individuals, such as those that are affiliated with a village 240.

As shown in FIG. 2, system 401 facilitates sponsorships of recipients. For example, system 401 recognizes the sponsorship of individuals, such as the sponsorship of recipient 230A by distributor 210A, the sponsorship of recipient 230B by distributor 210B, the sponsorship of recipient 230C by distributor 210C. Also, system 401 recognizes the sponsorship of groups of individuals, such as the sponsorship of village 240 by the organization 220. In one embodiment, the system 401 assigns sponsorship relationships. In another embodiment, system 401 allows the distributor or group of distributors to select a recipient for sponsorship.

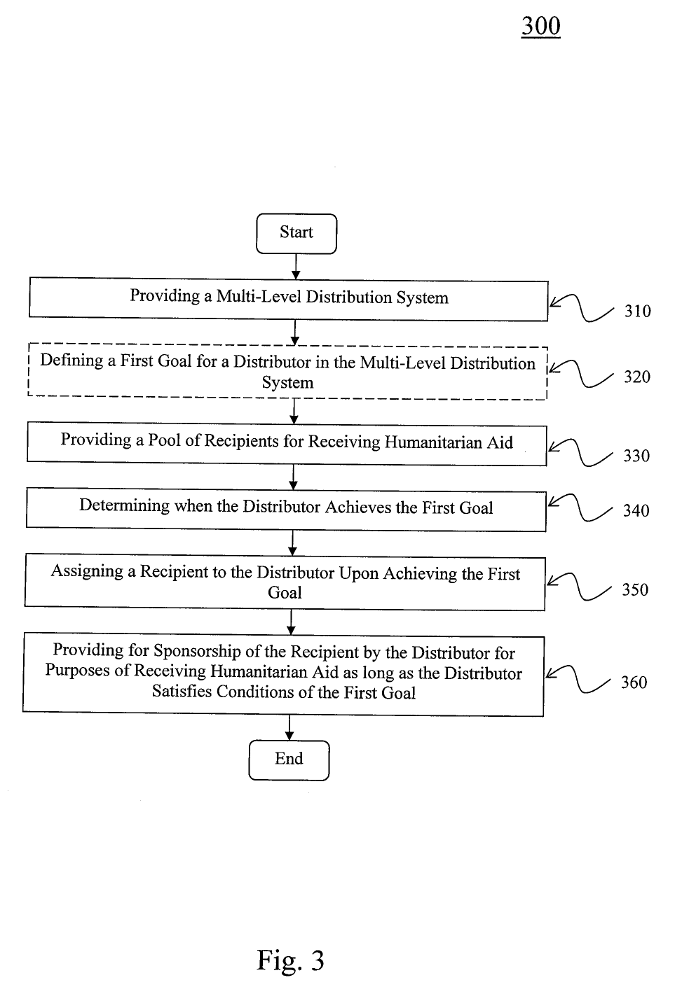

FIG. 3 is a flow chart 300 of a method for providing humanitarian aid, in accordance with one embodiment of the present invention. For instance, the flow chart 300 can be implemented within the system 200 of FIG. 2 to facilitate sponsorship of a recipient (e.g., child) by a distributor of a multi-level distribution system.

While embodiments of the present invention are described as being implemented within the context of a multi-level distribution system, other embodiments are well suited to providing humanitarian aid to recipients through sponsorship in other types of organizations. For instance, in a general corporate environment, sponsorships can be earned and maintained through the achievement of one or more goals.

At 310, a multi-level distribution system is provided. The multi-level distribution system is analogous to the system 100 described in FIG. 1. As such, the multi-level distribution system includes a plurality of distributors, or networked distributors. Each of the distributors is able to distribute a good or service of a parent company through the multi-level distribution system. Typically, a hierarchy of distributors can be established, wherein downstream or lower level distributors are recruited by a distributor located directly above in the hierarchy, as shown in FIG. 1 as an example. For purposes of the present embodiment, where a distributor is within the hierarchy is of limited significance. Embodiments of the present invention provide for sponsorship of a recipient by any distributor within a multi-level distribution system.

At 320, optionally a first goal is defined for purposes of providing humanitarian aid through sponsorship of a recipient. The goal can consist of any performance goal. Achievement of the conditions of the performance goal enables a distributor to begin and continue sponsorship of a recipient. For instance, one goal, previously described, is enrollment or participation in a monthly automatic shipping program. More specifically, a distributor enrolling in the program automatically orders a set amount of goods or services for a given period (e.g., monthly). Many times, the set amount of goods or services is approximately equal to an amount that is used by the distributor on a monthly basis. As such, at a minimum even if the distributor is not reselling any product or services, the goods or services ordered on a monthly basis would satisfy the needs of the distributor, and would not be wasted.

As an example, a multi-level distribution system may provide personal care products, as well as supplemental nutritional items. Other products and services may be provided by other multi-level distribution systems. In the present example, the distributor enrolling the automatic shipping program would automatically order a given set of products taken from personal care products. On a monthly basis, the set may contain the same products. In other cases, the products may change at the request of the distributor.

In all cases, the volume, cost of purchase, or some other valuation of the products and services exceeds a threshold. For instance, in one case, the amount ordered and purchased on a monthly basis must exceed $100.00 US, as the threshold. In another case, the volume of products and services ordered must exceed a point valuation of 100 points. For instance, points for a product may be given as a percentage of the total purchase price of the product. As an example, a product that costs $100.00 would have a point valuation of approximately 80 points. In this case, at least one other product would have to be ordered to exceed the 100 point threshold.

Other embodiments are well suited to other goals, or other types of performance goals. For instance, a number of recruits attracted by or associated with a distributor in a given period may be a goal. Total number of downline distributors for a particular distributor may be a goal. Total sales or purchase volume may define another goal. In addition, a purchase of a promoted good or service may be listed as a goal. Exceeding a threshold for purchases of goods or services may be a goal. Also, exceeding a threshold for downline purchases of goods or services may be a goal. As can be seen, any type of goal may be defined for purposes of beginning and continuing sponsorship of a recipient.

At 330, a pool of recipients is provided for receiving humanitarian aid. The pool of recipients includes a plurality of individuals. The pool of recipients may be associated with one or more geographic regions, countries, villages, or some other natural grouping of individuals (e.g., state, city, township, etc.).

In addition, the recipients may be associated with one or more projects that are supported by the parent company of the multi-level distribution system. That is, at least one humanitarian project is provided for the benefit of the pool of recipients. As such, humanitarian aid is provided in association with the project.

For instance, a humanitarian aid project may be implemented for a particular village in a country. Individuals in that village are eligible to be included in the pool of recipients. Other projects may also be included. As such, individuals receiving the benefit of these other projects would be eligible to be included in the pool of recipients. In one case, these projects would continue regardless of the impact of any sponsorship of particular individuals. In another case, the recipient of humanitarian aid, at least in part, benefits directly from the sponsorship of particular individuals.

In one embodiment, the pool of recipients is limited to children. For instance, children less than 10 are eligible for inclusion within the pool of recipients. Of course, in other embodiments, the pool of recipients is not limited to children, and may include adults, and family members, etc.

At 340, a determination is made when the distributor reaches the first goal, or satisfies the conditions of the first goal. That is, performance of the distributor is tracked in order to determine if and when the distributor first meets the conditions of the first goal, and also, to determine if the distributor continues to satisfy the conditions of the first goal. For instance, if the first goal is to maintain a monthly automatic shipping program, then at 340, it can be determined when the distributor first enrolls in the automatic shipping program, thereby meeting the initial conditions of the first goal. In addition, at 340, it can be determined if the distributor continues to participate in the automatic shipping program, thereby meeting the continuing conditions of the first goal.

In another embodiment, once the distributor satisfies the conditions of a first goal, a sponsorship of a recipient by the distributor is created. Thereafter, the distributor must satisfy the conditions of succeeding goals over defined periods to maintain the sponsorship. At 340, performance of the distributor is monitored to determine if and when the distributor reaches the first goal to start the sponsorship, and any subsequent goal or goals to maintain the sponsorship.

At 350, a recipient is assigned to the distributor upon achieving the first goal. For instance, once the distributor enrolls in the automatic shipping program to receive a given set of products on a monthly basis, then the distributor is eligible for sponsoring a recipient. In one case, the recipient is assigned to the distributor from the pool of recipients, without any input from the distributor. In another case, recipients in the pool of recipients are presented to the distributor for selection. As such, upon receipt of the selection of a recipient, sponsorship of the selected recipient is assigned to that distributor.

In one embodiment, once a recipient is assigned to a distributor, that recipient is unable to be assigned to another distributor in any multi-level distribution system participating in the sponsorship program. That is, the recipient is prevented from being assigned to another distributor. In another case, the recipient is prevented from being assigned to another distributor, as long as the second distributor is participating in the same multi-level distribution system. Of course, other embodiments are well suited to allow for multiple assignments to be made for a single recipient to multiple distributors, both within the same or outside a multi-level distribution system.

At 360, sponsorship of the recipient is provided by the distributor for purposes of receiving humanitarian aid. The sponsorship continues as long as the distributor satisfies conditions of the first goal. For instance, as long as the distributor maintains enrollment in an automatic shipping program, the sponsorship of that particular recipient is maintained.

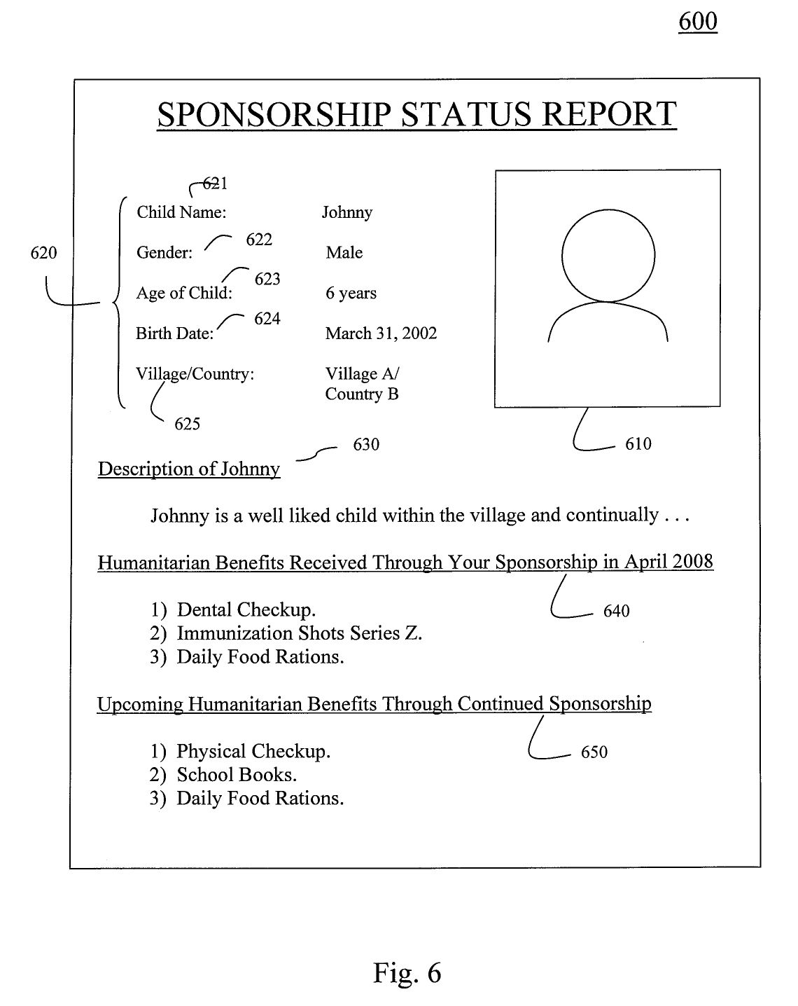

In another embodiment, a status of the recipient is provided. For instance, the status report 600 of FIG. 6 is accessible to the distributor, such as through a web portal maintained by the server in association with the multi-level distribution system, as described previously. As such, within the status report, updates of the receipt of humanitarian aid is provided.

The method of FIG. 3 is implementable with a system for providing humanitarian aid, in accordance with one embodiment of the present invention. For instance, the system includes means for providing a multi-level distribution system that distributes goods and services through a plurality of distributors. The system also includes means for providing a pool of recipients each of which is targeted for receiving humanitarian aid. In one case a recipient is a child, and as such, the child is specifically targeted for receiving humanitarian aid. The system also includes means for determining when a distributor participating in the multi-level distribution system achieves a goal. In one case, the goal is a performance goal, such as participation within an autoship program that automatically ships a predesignated set of goods and/or services for every defined period (e.g., shipping on a monthly basis). Also, the system includes means for assigning a recipient to the distributor upon achieving the first goal. In one case, the distributor is able to select a recipient from a plurality of recipients for purposes of sponsoring that recipient, such that the recipient receives humanitarian aid through the sponsorship. More specifically, the system includes means for providing sponsorship of the recipient by the distributor for purposes of receiving humanitarian aid as long as the distributor satisfies conditions of the first goal.

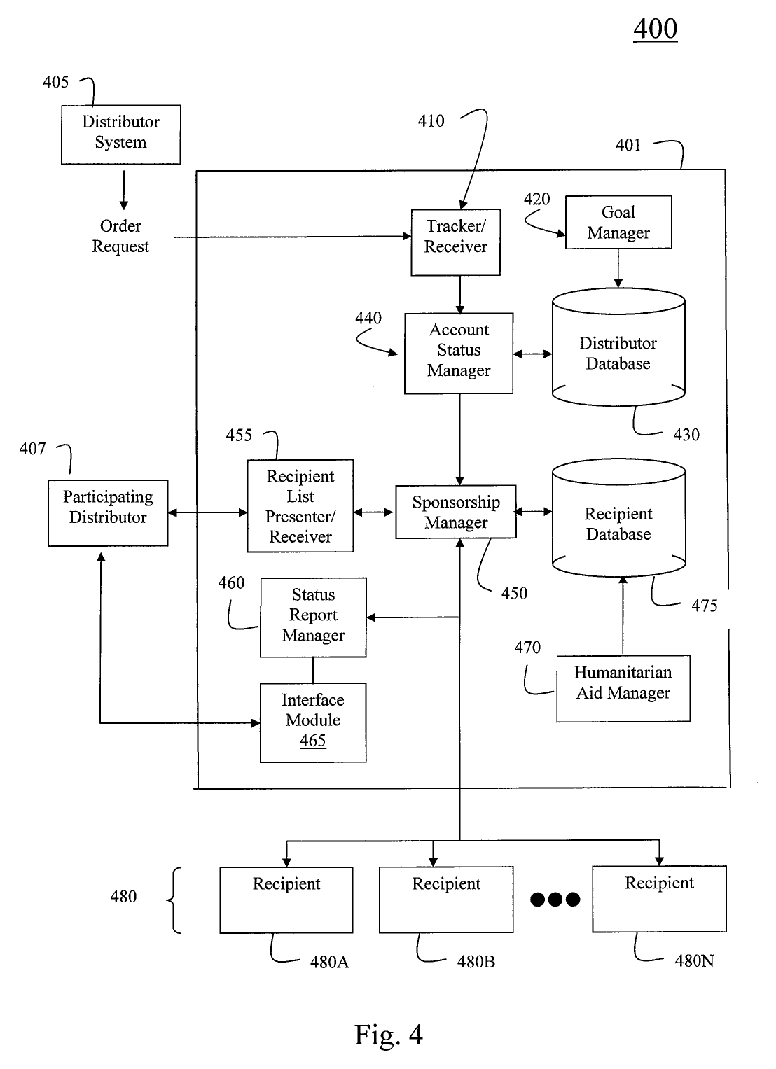

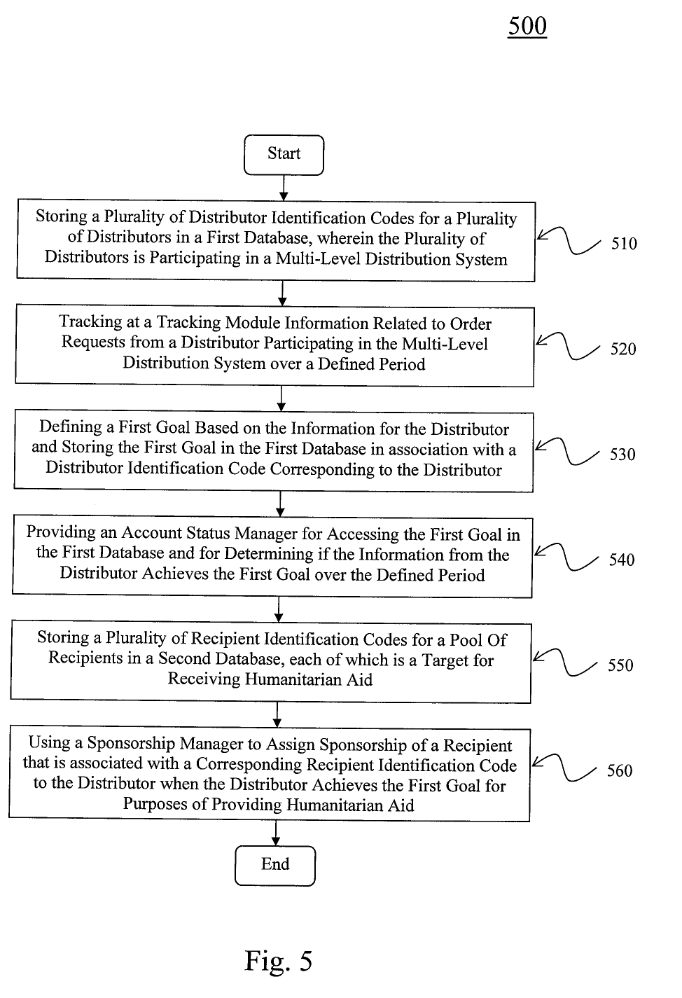

FIGS. 4 and 5, in combination, illustrate a method and system for providing humanitarian aid, in accordance with embodiments of the present invention. FIG. 4 illustrates a data flow diagram 400 illustrating the flow of information through a sponsorship distributor 401, first shown in FIG. 1. Also, FIG. 5 illustrates a method for providing humanitarian aid, as implemented, in part, through sponsorship distributor 401, in accordance with embodiments of the present invention.

Turning now to FIG. 4, a block diagram of a sponsorship distributor 401 is shown that is capable of facilitating the provision of humanitarian aid through sponsorship of recipients, in accordance with one embodiment of the present invention. Specifically, in FIG. 4 a data flow diagram 400 illustrates the flow of information through the sponsorship distributor 401 that is capable of facilitating relationships between a recipient and a sponsor distributor. The distributor is participating in a multi-level distribution system that distributes goods, services, or a combination of goods and services. For instance, system 401 is capable of recognizing and creating sponsorship relationships between the recipients and distributors shown in FIG. 2.

Sponsorship distributor 401 may be consolidated into a single unit, as shown in FIG. 4, or distributed throughout a communication network. In either case, the modules of sponsorship distributor 401 are capable of communicating with each other to facilitate the sponsorship of a recipient by a distributor participating in a multi-level distribution system for purposes of providing humanitarian aid to the recipient. As such, sponsorship distributor 401 provides the control center for managing the sponsorship of recipients.

A distributor system 405 communicates with sponsorship distributor 401. For instance, system 405 may be associated with a single distributor and is used for communication. In that case, system 405 may be a web browser, user interface, or any other suitable interface used by a distributor to communicate with sponsorship distributor 401. As an example, system 405 may be used by a distributor for making order requests ordering goods or services provided by the multi-level distribution system. Additionally, system 405 may be used to send information related to order requests to sponsorship distributor 401. For instance, this information may include order requests for downline distributors, the number of downline distributors associated with a distributor, the number of downline distributors that were recruited by the distributor during a defined period, purchase orders by the distributor, etc.

As shown in FIG. 4, a distributor database 430 is included within the sponsorship distributor 401. Database 430 stores a plurality of distributor identification codes for a plurality of distributors participating in the multi-level distribution system. That is, each distributor is identifiable using a corresponding identification code.

For instance, turning now to FIG. 5, the plurality of distributor identification codes is stored for the plurality of distributors in database 430. In addition, information related to each of the distributors can be included in database 430. As such, additional information related to the distributor can be referenced using the corresponding identification code. This additional information may include performance goals associated with the distributor, order requests made by the distributor, the number of downline distributors associated with the distributor, the number of recruited downline distributors associated with the distributor, etc.

Returning to FIG. 4, sponsorship distributor 401 includes a tracker/receiver 410. The receiver portion 410 is capable of receiving communication from the distributor system 405. For instance, tracker/receiver 410 is able to receive information related to order requests from distributor system 405 associated with a corresponding distributor. More specifically, tracker/receiver 410 is capable of tracking the performance of distributors in the multi-level distribution system. That is, in relation to 520 of FIG. 5, performance criteria, such as information related to order requests from a distributor, and other variables critical to defining the performance of the distributor is recognized, tracked, and monitored by tracker/receiver 410 over a defined period.

System 401 also optionally includes a goal manager 420. The goal manager 420 defines one or more performance goals for the distributor or group of distributors to satisfy for sponsorship purposes. These goals are stored by manager 420 in database 430 in relation to corresponding distributors and their identification codes.

Specifically, as provided in FIG. 5, goal manager 420 is capable of implementing 530 in flow diagram 500, by defining a goal based on information related to order requests. Satisfaction of the goal begins or continues sponsorship of the sponsored recipient. In addition, performance goals are stored in the first database 430 in association with corresponding distributors. That is, for a distributor, the goal manager 420 is capable of defining a goal that is related to the information received from the distributor system 405 and storing the goal in association with a corresponding distributor identification code. As such, the associated performance goal is available for later access through the database 430 using the distributor identification code.

As an example, one goal is for a distributor to purchase a certain amount of goods or services each month. Another goal is for a distributor to purchase a certain amount of goods or services each month through an automatic shipping program. Another goal is for a distributor to purchase a promoted good or service. Still another goal is for a distributor to recruit a certain amount of downline distributors in a period. Still another goal is for a distributor to reach a certain level of downline distributors. Any number of goals can be designed for a distributor or group of distributors to meet in order to begin or continue sponsorship of a recipient.

System 401 also includes a humanitarian aid manager 470. A pool of recipients is created and managed by the humanitarian aid manager 470. In one embodiment, recipients in the pool are targeted through sponsorship to receive humanitarian aid. The recipients available for sponsorship by a distributor are individuals, in one embodiment. More particularly, a recipient is a child that is targeted for receiving humanitarian aid through sponsorship.

While embodiments of the present invention are described as sponsoring a recipient that is an individual, such as a child, other embodiments are well suited to sponsorship of recipients of groups of individuals, or other entities (e.g., village). For instance, one or more distributors may, as an organization, sponsor an entity, such as a village.

In addition, each of the recipients in the pool is associated with a recipient identification code. In one instance, the humanitarian aid manager 470 creates and associates a recipient identification code with a corresponding recipient. Further, manager 470 is able to store a plurality of identification codes for the pool of recipients in the recipient database 475. As provided in FIG. 5, manager 470 is capable of implementing 550 in flow diagram 500, by storing the plurality of recipient identification codes for the pool of recipients in database.

An account status manager 440 is also included in sponsorship distributor 401. The account status manager 440 accesses the first goal in the first database for comparison with information received from the distributor system 405. As such, account status manager 440 is capable of determining when a distributor reaches a performance goal, thereby qualifying the distributor to become a sponsor of a recipient, or to maintain sponsorship of a recipient.

More particularly, as provided in FIG. 5, account status manager 440 is capable of implementing 540 in flow diagram 500, by determining if the information achieves or satisfies the first goal over the defined period. As a result, as long as a distributor meets one or more defined performance goals, that distributor is able to begin or continue sponsorship of a recipient, for purposes of receiving humanitarian aid.

Distributor 401 also includes a sponsorship manager 450 that is able to facilitate the relationship between the distributor and the recipient. As provided in FIG. 5, sponsorship manager 450 is capable of implementing 560 in flow diagram 500, by assigning sponsorship of a recipient to the distributor, when the distributor achieves the corresponding performance goal. For instance, the distributor associated with the distributor system 405 is assigned sponsorship of one of the plurality of sponsored recipients 480 (e.g., 480A, or 480B, etc.). As such, humanitarian aid is provided through the sponsorship of the recipient.

In another instance, sponsorship manager 450 provides for selection of the recipient by the distributor. As shown in FIG. 4, recipient list presenter/receiver 455 is capable of presenting the available recipients from the pool of recipients to a user interface, or any type of communication interface, associated with the distributor 407. In one instance, the distributor 407 may be associated with distributor system 405. Available recipients in the pool of recipients are presented for selection by the distributor 407. In turn, the distributor 407 is able to select a selected recipient through the user interface. Notification of the selection of the selected recipient is provided back to the presenter/receiver 455.

As such the sponsorship manager 450 is able to make an association between the distributor and the recipient for sponsorship purposes. Specifically, the recipient is identified with a corresponding recipient identification code, and the corresponding distributor providing sponsorship is identified by a corresponding distributor identification code. As such, the sponsorship association between the distributor and the recipient can also be stored in either or both of the databases 430 and 475. That is, sponsorship information can be stored in distributor database 430 such that the sponsored recipient can be accessed for a particular distributor, using the distributor identification code. Correspondingly, sponsorship information can be stored in database 475, such that the sponsoring distributor can be accessed for a recipient, using the recipient identification code.

In addition, the sponsorship of the recipient is continued as long as the corresponding goal is satisfied, in one embodiment. For instance, the goal may be to participate in an automatic shipping program for purchasing and receiving product or service offered by the multi-level distribution system. Those items are shipped automatically on a periodic basis (e.g., monthly). As long as the distributor participates in the automatic shipping program, the distributor's sponsorship of a recipient continues.

In addition, that sponsorship of the recipient is continued as long as the corresponding goal is satisfied, and any other additional goals, as follow-on conditions for sponsorship, are satisfied, in another embodiment. For instance, again using the automatic shipping program, the initial goal may be to begin participation in an automatic shipping program for purchasing and receiving product or service offered by the parent company on a periodic basis (e.g., monthly). Once participation begins, then sponsorship is established between the distributor and a recipient. Follow-on goals could be to maintain participation in the automatic shipping program, for each period. As such, as long as the distributor maintains participation in the automatic shipping program, the distributor satisfies the follow-on goals, and the distributor's sponsorship of a recipient continues.

In still another embodiment, sponsorship of a recipient is exclusive to a sponsoring distributor. Specifically, once that recipient is sponsored, additional sponsorships of that recipient is prevented by a second or other distributors participating in the multi-level distribution system. This exclusivity continues as long as the sponsoring distributor maintains the sponsorship of the recipient.

In still another embodiment, sponsorship manager 450 also executes instructions for purposes of providing humanitarian aid, for the benefit of the sponsored recipient. For instance, the instructions may include means for distributing a donation to a humanitarian aid program that is servicing the needs of the sponsored recipient. The donation may be given to the humanitarian aid program, for purposes of generally providing humanitarian aid to the sponsored recipient. That is, the donation indirectly provides aid to the sponsored child through the humanitarian aid program. Additionally, the donation may be given to a humanitarian aid program, for the specific purpose of benefiting the sponsored recipient. That is, because of the donation, the sponsored child directly receives humanitarian aid, as applied through a humanitarian aid program.

System 401 also includes a status report manager 460. To build the relationship between the sponsor and the recipient, the report manager 460 provides up-to-date information on the well-being of the recipient that is accessible by the corresponding distributor. That is, report manager 460 is capable of generating status reports for the plurality of sponsored recipients 480. For instance, the status report may include background information about the sponsored recipient, as well as the latest benefits received by the recipient, as a result of the distributor's sponsorship. As such, report manager 460 is able to collect information and present the information to interested distributors. A more detailed discussion of an exemplary report is provided in relation to FIG. 6.

Interface module 465 provides an avenue for distributors to access the reports generated by the report manager 460. As examples, the participating distributor 407 may access the interface module 465 from various locations, including a home computer, a mobile phone, mail, etc. As such, the participating distributor 407 may receive a request for a corresponding status report from a user interface associated with the distributor 407. The distributor may present the identification code, or any other suitable identifier, for the corresponding recipient that is sponsored by the distributor to the interface module 465. Via the interface module 465, using the recipient identification code, the proper report may be accessed and presented to user interface associated with the requesting distributor 407.

FIG. 6 is an illustration of a status report 600 providing general information of a sponsored recipient, and an update as to the benefits received by the sponsored recipient, in accordance with one embodiment of the present invention. The status report 600 is able to provide a window into the life of the recipient that is accessible by the sponsoring distributor.

For instance, FIG. 6 is reflective of a distributor's sponsorship of a child recipient. The distributor has achieved a goal in order to obtain a sponsorship of the child recipient. In addition, the distributor has satisfied the conditions of the goal, or follow-on goals, in order to maintain the sponsorship of the child recipient. The status report 600 provides general information about the child recipient, as well as information about the benefits received by the child recipient. In such a way, a relationship between the distributor and the child recipient is able to go beyond mere sponsorship.

In one embodiment, the status report 600 is managed by the report manager 460 of system 401. Access to the status report 600 is available through a server via a communication network (e.g., internet), as an illustration. For instance, the multi-level distribution system may provide an internet based server system (not shown) that facilitates communication between distributors and the parent company. In one case, the server system may include features of system 401. As an example, the server system may provide means for placing orders for product or service by the distributors.

In addition, other general information of interest to the distributors may be included in the server system. For instance, in one embodiment, the server system may manage personal pages for each of their distributors. By accessing a corresponding personal page, a distributor is able to access general information, make orders for product or services, track their performance within the multi-level distribution system, and access the status report 600.

As shown in FIG. 6, a picture of the child recipient is provided in block 610. The picture allows the distributor to place a face on the sponsorship. In addition, links within block 610 (e.g., clicking on the child) may provide a video showing the child recipient in his or her daily surroundings, or provide a short informational video on the background of the child recipient.

Status report 600 also includes general information section 620. Included within section 620 are information fields 621-625 that provide respective biographical information about child recipient, such as the name, gender, age, birth date, and other related geographic information. For instance, Johnny is a six year old male who lives in Village A of the Country B.

In addition, status report 600 also includes section 630 that provides a description of Johnny, the child recipient. Section 630 is intended to give the distributor general information about the child recipient in order to build a closer relationship between the two. For instance, information about Johnny's family, his village, good times, and bad times experienced by Johnny, etc. may be included.

Importantly, section 640 provides a listing of humanitarian benefits received through the sponsorship of the child recipient, Johnny. The listing is limited to the latest benefits received. For instance, the listing includes those benefits received in the last month, and are a direct result of the distributor satisfying his or her goal for the last period, such as the last month (e.g., automatic shipping of product or services on a monthly basis).

As shown in section 640 of FIG. 6, Johnny has received a dental checkup, series Z immunization shots, and daily food rations. In one embodiment, the child recipient has received these humanitarian benefits as a direct result of sponsorship. In another embodiment, the child recipient is part of a larger project that provides humanitarian aid generally to a group of recipients (e.g., a village), to include Johnny. As such, the aid would still be provided to Johnny regardless of sponsorship; however, with sponsorship by a particular distributor, extra care for monitoring progress may be taken for purposes of providing information for the status report 600, such as taking pictures or video of the child as he receives the aid. These pictures or videos could be accessible through the status report. For instance, a link to the picture or video would be placed next to the corresponding humanitarian aid that is reported. As an example, a picture of Johnny receiving a dental checkup is linked next to the first listing in section 640. In other cases the pictures or videos would generally be available to the distributor for access through the status report, or the distributor's personal page.

Section 650 provides a listing of upcoming humanitarian aid to be received through the continued sponsorship of the child recipient, Johnny. These benefits may be tied to a certain period, such as the next period for which the distributor must satisfy conditions of a first goal, or to satisfy conditions of a second goal, in order to continue sponsorship of the child recipient. In that manner, the distributor gains a sense of responsibility towards the child recipient in terms of the receipt of the upcoming humanitarian aid.

For instance, as shown in section 650, Johnny will be receiving a physical checkup, school books, and daily food rations. In one embodiment, these benefits will be received by Johnny as a direct result of the sponsorship by the distributor. In another embodiment, though Johnny will still receive the benefits through an overall humanitarian aid project, continued sponsorship allows the distributor to receive status reports that are current, and provide the latest information about the child recipient, Johnny. In this case, the distributor may have an affiliation to the child recipient through the sponsorship. Without continued sponsorship, status report 600 would not be available to the distributor who previously sponsored Johnny.

Status report 600 may include other information, not shown. For instance, status report 600 may also include a listing of all the benefits received by the child recipient, Johnny, since the beginning of sponsorship by the distributor. In this manner, the distributor is able to view this information and gain a sense of his or her involvement in the well being of the child recipient, Johnny. In that way, the distributor may take a sense of responsibility for the child receiving those benefits, as well as upcoming benefits.

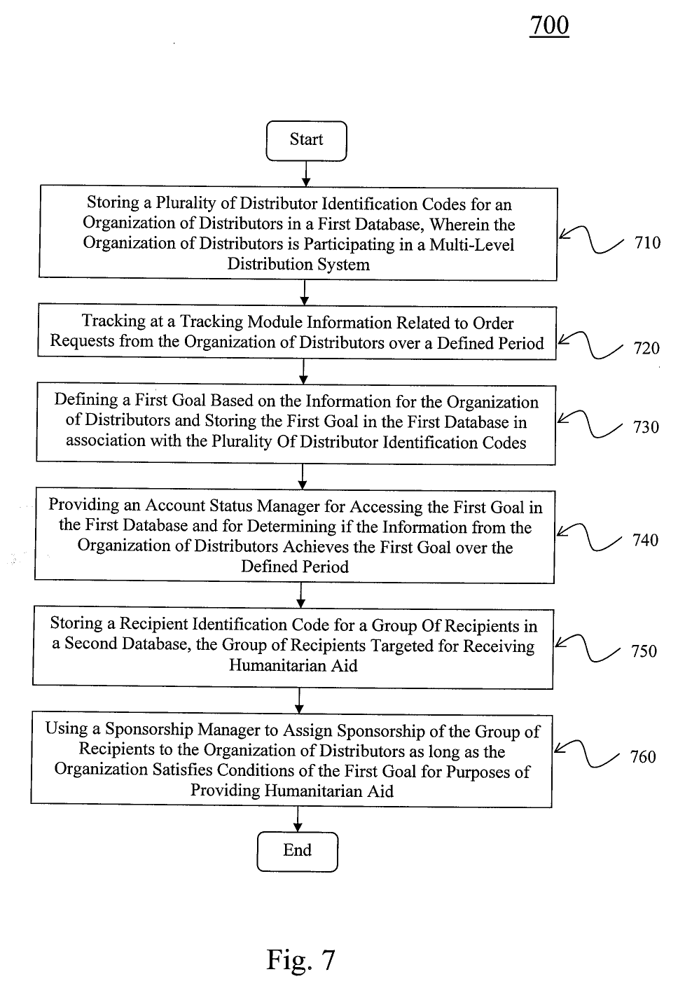

FIG. 7 is a flow diagram 700 of a method for providing humanitarian aid to a group of recipients (e.g., village), in accordance with one embodiment of the present invention. For instance, the flow chart 700 can be implemented within the system 200 of FIG. 2 and sponsorship distributor 400 of FIG. 4 to facilitate sponsorship of a group of recipients by an organization of distributors of a multi-level distribution system. In addition, the process outlined in flow chart 700 is analogous to the process outlined in flow chart 500 and its accompanying description; however, instead of an individual distributor sponsoring an individual recipient, in flow chart 700 a group of distributors sponsors a group of recipients, as will be described below.

In one embodiment, the method of FIG. 7 is implemented in association with participating by the distributors in a multi-level distribution system. The multi-level distribution system is analogous to the system 100 described in FIG. 1. As such, the multi-level distribution system includes a plurality of distributors, or networked distributors. Each of the distributors is able to distribute a good or service of a parent company through the multi-level distribution system. Typically, a hierarchy of distributors can be established, wherein downstream or lower level distributors are recruited by a distributor located directly above in the hierarchy, as shown in FIG. 1 as an example.

An organization of distributors is defined in the multi-level distribution system. As an example, organization 150 provides a plurality of distributors that are related, and includes a head distributor as well as multiple downstream distributors at various levels. In embodiments of the present invention, multiple organizations can be defined, each of which are capable of sponsoring one or more groups of recipients.

At 710, a plurality of distributor identification codes for the organization is stored in a first database. For instance, the plurality of identification codes is stored in distributor database 430 of FIG. 4. Also, an identification code for the organization may be created and stored in database 430. Information related to the organization, such as identification codes for each of the distributors of the organization may be stored and accessed using the organization identification code. Other information, including performance goals, order requests, etc. may also be included in database 430 in association with the distributors, or the organization.

At 720, information related to order requests from the organization of distributors is received and tracked using a tracking module. The information is tracked over a defined period. For instance, information includes those related to performance criteria, such as information related to order requests for distributors of the organization, and other variables critical to defining the performance of the organization. Since the distributors in the organization are known, the information related to those distributors are also related to the organization. As such, whenever any information is collected, such as information related to performance criteria, for any distributor in the organization, that information may also be associated with the organization for purposes of sponsorship and providing humanitarian aid.

At 730, a first goal is defined for the organization of distributors. In addition, the goal is stored in the database, such that is accessible for purposes of determining whether the goal was achieved or satisfied. Access can be via any of the identification codes related to the organization or the distributors in the organization. Satisfaction of the goal enables sponsorship of one or more recipients for purposes of providing humanitarian aid.

While the goal is defined for the organization, it may be partitioned into smaller parts based on the performance of distributors within the organization. For example, one goal may be to have eighty percent participation within an automatic shipping program. Another goal is to achieve a monthly sales total for the organization. A total number of downline distributors in the organization may be another goal. As can be seen, any type of goal may be defined for the organization for purposes of beginning and continuing sponsorship.

At 740, an account status manager is provided for accessing the first goal in the first database and for determining if the information from the organization of distributors achieves the first goal over the defined period. Specifically, a determination is made when the organization achieves the first goal, or satisfies the conditions of the first goal. That is, performance of the organization is tracked in order to determine if and when the organization first meets the conditions of the first goal, and also, to determine if the organization continues to satisfy the conditions of the first goal.

At 750, a recipient identification code is stored in a second database. The recipient identification code is associated with a group of recipients that is provided as a target for receiving humanitarian aid through sponsorship by the organization. For instance, the group of recipients may be a village of recipients. As such, the recipients in the group are the individuals associated with the village (e.g., children, women, men, etc.). The group of recipients may also be associated with a particular project that is providing humanitarian aid to the group. As such, the group may include one or more villages, or may include a group of loosely associated individuals.

At 760, sponsorship of the village is assigned to the organization upon achieving the first goal using a sponsorship manager. Specifically, sponsorship of the group of recipients is assigned to the organization of distributors. For instance, once the organization reaches its goal, then the organization is eligible for sponsorship, and the village is assigned to the organization for purposes of receiving humanitarian aid. Sponsorship continues as long as the organization continues to satisfy the conditions of the first goal. For instance, as long as the organization achieves eighty percent participation within the automatic shipping program, then the organization is continually assigned to the village for sponsorship.

In another embodiment, sponsorship continues as long as the organization satisfies a second goal. For instance, once sponsorship begins, the first goal has been reached and satisfied. Thereafter, a second goal is defined for the organization. Conditions of the second goal must be satisfied by the organization within a second time period (e.g., a month) in order to continue sponsorship of the village. For instance, if the goal is to achieve eighty percent participation by the distributors in an organization within the automatic shipping program, then if this condition is satisfied in the second month, the sponsorship would continue.

In one embodiment, a status of the village is provided to distributors in the organization. The status is analogous to the status report 600, except the information provided is for the group of recipients, and not just one individual.

In one embodiment, contributions of each distributor are available for peer review. These contributions are used to determine if the organization is able to begin sponsorship of the group of recipients and to maintain sponsorship of the group. Opening for peer review may provide a sense of camaraderie between the distributors in the organization for sponsorship of the group of recipients. That is, the peer review may induce increased participation on the part of distributors to reach goals necessary to begin and maintain sponsorship.

While the methods of embodiments illustrated in flow charts 3, 5, and 7 show specific sequences and quantity of operations, the present invention is suitable to alternative embodiments. For example, not all the operations provided for in the methods presented above are required for the present invention. Furthermore, additional operations can be added to the operations presented in the present embodiments. Likewise the sequences of operations can be modified depending upon the application.

A method and system for sponsorship of a recipient by a distributor in a multi-level distribution system for purposes of providing humanitarian aid to the child is thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

What is claimed:

1. A method for promoting humanitarian aid, comprising:
storing a plurality of distributor identification codes for a plurality of distributors in a first database, wherein said plurality of distributors is participating in a multi-level distribution system;
tracking at a tracking module information related to order requests from a distributor participating in said multi-level distribution system over a defined period;
defining a first goal based on said information for said distributor and storing said first goal in said first database in association with a distributor identification code corresponding to said distributor;
providing an account status manager for accessing said first goal in said first database and for determining if said information from said distributor achieves said first goal over said defined period;
storing a plurality of recipient identification codes for a pool of recipients in a second database, each of which is a target for receiving humanitarian aid; and
using a sponsorship manager to assign sponsorship of a recipient that is associated with a corresponding recipient identification code to said distributor when said distributor achieves said first goal for purposes of providing humanitarian aid.

2. The method of claim 1, wherein said providing a multi-level distribution system further comprises:
providing the distribution of goods in said multi-level distribution system.

3. The method of claim 1, further comprising:
receiving a request for a status report for said recipient from a user interface associated with said distributor; and
providing said status report of said recipient to said user interface.

4. The method of claim 1, further comprising:
providing at least one humanitarian project for the benefit of said pool of recipients; and
providing humanitarian aid to said recipient under one of said at least one humanitarian project.

5. The method of claim 1, further comprising:
preventing sponsorship of said recipient by a second distributor participating in said multi-level distribution system as long as said distributor is sponsoring said recipient.

6. The method of claim 1, wherein said providing a pool of recipients comprises:
providing a child as a recipient in said pool of recipients.

7. The method of claim 1, wherein said using a sponsorship manager to assign sponsorship further comprises:
presenting a plurality of recipients from said pool of recipients to a user interface associated with said distributor, said plurality of recipients presented for selection by said distributor; and
receiving selection of said recipient from said user interface.

8. The method of claim 1, further comprising:
providing a second goal for said distributor to satisfy within a second defined period not overlapping said defined period; and
providing continued sponsorship of said recipient by said distributor as long as said distributor satisfies said second goal.

9. The method of claim 1, further comprising:
defining said first goal as participation by said distributor in an automatic shipping program for user specified goods, wherein said automatic shipping program is continuing.

10. The method of claim 1, wherein said first goal is taken from a group consisting essentially of:
a purchase of a promoted good or service;
exceeding a first threshold for purchases of goods or services;
exceeding a second threshold for downline purchases of goods or services;
exceeding a third threshold for recruiting downline distributors; and
exceeding a fifth threshold for the number of downline distributors.

11. A method for promoting humanitarian aid, comprising:
storing a plurality of distributor identification codes for an organization of distributors in a first database, wherein said organization of distributors is participating in a multi-level distribution system;
tracking at a tracking module information related to order requests from said organization of distributors over a defined period;
defining a first goal based on said information for said organization of distributors and storing said first goal in said first database in association with said plurality of distributor identification codes;
providing an account status manager for accessing said first goal in said first database and for determining if said information from said organization of distributors achieves said first goal over said defined period;
storing a recipient identification code for a group of recipients in a second database, said group of recipients targeted for receiving humanitarian aid;
using a sponsorship manager to assign sponsorship of said group of recipients to said organization of distributors as long as said organization satisfies conditions of said first goal for purposes of providing humanitarian aid.

12. The method of claim 11, further comprising:
receiving a request for a status report for said group of recipients from a user interface associated with a distributor in said organization of distributors; and
providing said status report of said group of recipients to said user interface.

13. The method of claim 11, further comprising:
defining a second goal for said organization to satisfy within a second defined period not overlapping said defined period; and
providing continued sponsorship of said recipient by said organization as long as said second goal is satisfied.

14. The method of claim 11, wherein said defining a first goal comprises:
defining said first goal as exceeding a total sales volume for a time period for said organization.

15. The method of claim 11, further comprising:
providing for peer review, contributions of each distributor in said organization of distributors towards achieving said first goal.

16. The method of claim 11, wherein said group of recipients comprises a village.

17. A system for promoting humanitarian aid, comprising:
a multi-level distribution system;
a distributor participating in said multi-level distribution system;
a performance goal for measuring performance of said distributor; and
a recipient for receiving humanitarian aid that is assigned to said distributor, wherein said recipient is sponsored by said distributor for purposes of receiving humanitarian aid as long as said distributor satisfies conditions of said performance goal

18. The system of claim 17, further comprising:
a plurality of distributors participating in said multi-level distribution system; and
a pool of recipients available for sponsorship by said plurality of distributors, each sponsored recipient receiving humanitarian aid as long as a corresponding sponsoring distributor satisfies conditions of a corresponding performance goal.

19. The system of claim 18, further comprising:
a humanitarian aid project providing humanitarian aid to sponsored recipients in said pool of recipients.

20. The system of claim 17, wherein said recipient is a child.

21. The system of claim 17, wherein said performance goal is participation in an automatic shipping program.

22. A system for promoting humanitarian aid, comprising:
a first database for storing a plurality of distributor identification codes for a plurality of distributors, wherein said plurality of distributors is participating in a multi-level distribution system;
a tracker for tracking information related to order requests from a distributor participating in said multi-level distribution system over a defined period;
a goal manager for defining a first goal based on said information for said distributor and storing said first goal in said first database in association with a distributor identification code corresponding to said distributor;
an account status manager coupled to said tracking module for accessing said first goal in said first database and for determining if said information from said distributor achieves said first goal over said defined period;
a humanitarian aid manager for providing a pool of recipients targeted for receiving humanitarian aid;
a second database for storing a plurality of recipient identification codes for said pool of recipients; and
a sponsorship manager for assign sponsorship of a recipient that is associated with a corresponding identification code to said distributor when said distributor achieves said first goal for purposes of providing humanitarian aid.

23. The system of claim 22 further comprising:
a status report manager for providing a status report of said recipient for access by said distributor.

24. The system of claim 22, further comprising:
a benefit manager for presenting a plurality of benefits to a user interface associated with said distributor, said plurality of benefits presented for selection, and receiving selection of a selected benefit, and for delivering instructions such that said recipient receives said selected benefit.

25. A system for promoting humanitarian aid, comprising:
means for providing a multi-level distribution system;
means for providing a pool of recipients for receiving humanitarian aid;
means for determining when a distributor participating in said multi-level distribution system achieves a first goal;
means for assigning a recipient to said distributor upon achieving said first goal; and
means for providing for sponsorship of said recipient by said distributor for purposes of receiving humanitarian aid as long as said distributor satisfies conditions of said first goal.

26. A method for promoting humanitarian aid, comprising:
providing a multi-level distribution system;
providing a pool of recipients targeted for receiving humanitarian aid;
determining when a distributor participating in said multi-level distribution system achieves a first goal;
assigning a recipient to said distributor upon achieving said first goal; and
providing for sponsorship of said recipient by said distributor for purposes of receiving humanitarian aid as long as said distributor satisfies conditions of said first goal.
